(19) United States
(12) Patent Application Publication
(10) Pub. No.: US 2010/0133390 A1
(43) Pub. Date: Jun. 3, 2010

(54) Variable Angle Fitting

(76) Inventors: Timothy G. Lange, Champlin, MN (US); Jamie Livgard, Big Lake, MN (US); Brian B. Krause, Delano, MN (US); Ronald Malles, Saint Paul, MN (US)

Correspondence Address: GREENBERG TRAURIG (PHX), INTELLECTUAL PROPERTY DEPARTMENT, 2450 COLORADO AVENUE , SUITE 400E, SANTA MONICA, CA, 90404, US

(21) Appl. No.: 12/621,437

(22) Filed: Nov. 18, 2009

Related U.S. Application Data
(60) Provisional application No. 61/116,227, filed on Nov. 19, 2008.

(51) Int. Cl. F16L 3/08

(52) U.S. Cl. 248/65

(57) ABSTRACT

Embodiments of the invention provide a variable angle fitting to route cables around a corner. The variable angle fitting includes a main body with a base plate, a first sidewall, a second sidewall, a first joint plate, and a second joint plate. The first joint plate can be rotatably coupled to the base plate by a first deformable hinge, and the second joint plate can be rotatably coupled to the base plate by a second deformable hinge. The variable angle fitting also includes a first bracket and a second bracket that is identical to the first bracket. The first bracket can be coupled to the first joint plate, and the second bracket can be coupled to the second joint plate. The first bracket can be positioned at a first angle with respect to the base plate, and the second bracket can be positioned at a second angle with respect to the base plate in order to route cables around the corner.

### RELATED APPLICATIONS

This application claims priority under 35 U.S.C. §119 to U.S. Provisional Patent Application No. 61/116,227 filed on Nov. 19, 2008, the entire contents of which is incorporated herein by reference.

### BACKGROUND

Cable routing devices often include wireways, cable trays, and cable managers. In manufacturing facilities, the cable routing devices guard the installed wires and cables from unintentional removal and damage from the environment.

Numerous connectors exist for conventional cable routing devices. Although some connectors are used to join two straight wireways to lengthen the cable run, many connectors are used to introduce a change of direction in the cable route. Conventional connectors provide a fixed change of direction and do not always allow for the flexible routing layouts dictated by the equipment.

### SUMMARY

Some embodiments of the invention provide a variable angle fitting to route cables around a corner. The variable angle fitting includes a main body with a base plate, a first sidewall, a second sidewall, a first joint plate, and a second joint plate. The first sidewall and the second sidewall can be substantially perpendicular to the base plate. The first joint plate can be rotatably coupled to the base plate by a first deformable hinge, and the second joint plate can be rotatably coupled to the base plate by a second deformable hinge. The variable angle fitting also includes a first bracket and a second bracket that is identical to the first bracket. The first bracket can be coupled to the first joint plate, and the second bracket can be coupled to the second joint plate. The first bracket can be positioned at a first angle with respect to the base plate, and the second bracket can be positioned at a second angle with respect to the base plate in order to route cables around the corner.

### DESCRIPTION OF THE DRAWINGS

FIG. 1 is a perspective view of a variable angle fitting including a main body, a bracket, and a cover according to one embodiment of the invention.

FIG. 2 is an exploded view of the variable angle fitting of FIG. 1.

FIG. 3 is a perspective view of the main body of the variable angle fitting of FIG. 1.

FIG. 4 is a perspective view of the bracket of the variable angle fitting of FIG. 1.

FIG. 5 is a side view of the cover of the variable angle fitting of FIG. 1.

FIG. 6 is a cross-sectional view of the variable angle fitting of FIG. 1.

FIG. 7 is a side view of the variable angle fitting of FIG. 1 attached to cable routing devices according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

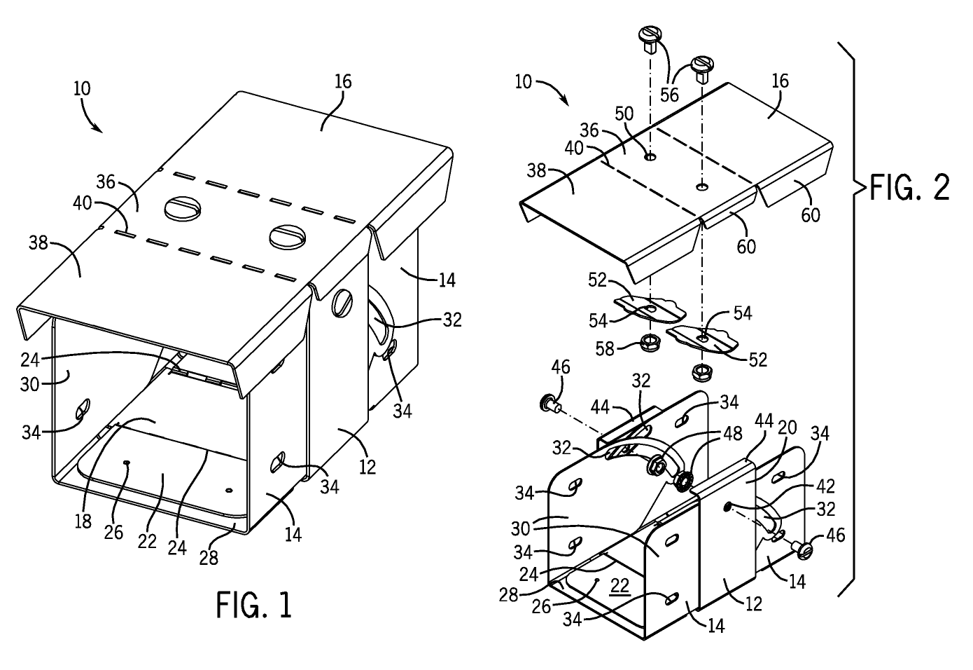

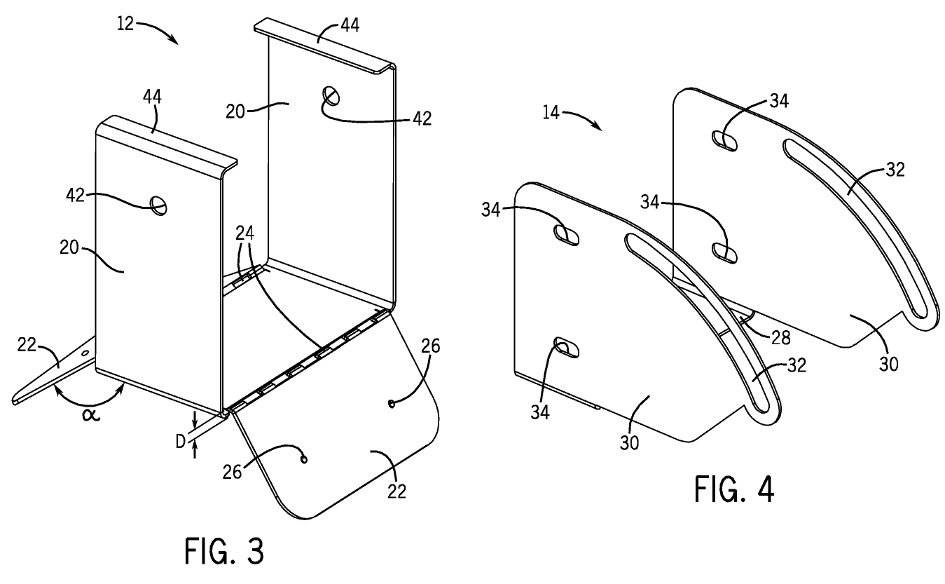

FIG. 1 illustrates a variable angle fitting 10 according to one embodiment of the invention. The variable angle fitting 10 can be used to connect cable routing devices, such as wireways, cable trays, and cable managers. The variable angle fitting 10 can include a main body 12, two brackets 14, and a cover 16. As shown in FIGS. 1-3, the main body 12 can include a base plate 18, a sidewall 20, and two joint plates 22. The joint plates 22 can be moveable with respect to the base plate 18. In some embodiments, as shown in FIG. 3, each joint plate 22 can be coupled to the base plate 18 by a deformable hinge 24. The joint plates 22 can include a fixture 26, which can be used to coupled the brackets 14 to the main body 12. The main body 12 can be wide enough to surround both the brackets 14. In some embodiments, the main body 12 can form a trough.

As shown in FIG. 4, the brackets 14 can each include a cross member 28, two sidewalls 30, slots 32, and four apertures 34. In some embodiments, the two brackets 14 can be substantially identical. One side wall 30 can be coupled to the other side wall 30 by the cross member 28. One slot 32 can be positioned in each sidewall 30. In some embodiments, the slot 32 can be elongated and curved. The two brackets 14 can be coupled to the main body 12. In some embodiments, the cross member 28 can be coupled to the joint plates 22 using the fixtures 26. The brackets 14 can move with respect to the main body 12. The brackets 14 and the joint plates 22 can rotate about the deformable hinges 24 with respect to the base plate 18. In this manner, the variable angle fitting 10 can form a living hinge.

As shown in FIG. 2, the cover 16 can include a first section 36, side sections 38, and two perforations 40. The perforations 40 can be positioned between the first section 36 and the side sections 38. In some embodiments, the first section 36 can at least partially cover the main body 12 and the side sections 38 can at least partially cover the brackets 14. In some embodiments, the perforations 40 can provide a flexible, deformable area allowing the side sections 38 to bend with respect to the first section 36. The perforations 40 can be strong enough to prevent the side sections 38 from detaching from the first section 36. In some embodiments, the perforations 40 can include a thinning of the material of the cover 16.

As shown in FIG. 2, the main body 12 can include openings 42 and flanges 44. One opening 42 can be positioned on each sidewall 20. In some embodiments, the opening 42 can be aligned with the slots 32. Screws 46 can be inserted through the openings 42. In some embodiments, the screws 46 can protrude through the sidewalls 20 and the slots 32 into an interior space of the variable angle fitting 10. A nut 48 can be coupled to each screw 46 to adjust a force exerted onto the sidewall 20 of the main body 12 and/or the sidewalls 30 of the brackets 14. The screws 46 and the nuts 48 can be used to fix a position of the brackets 14 with respect to the main body 12. Tightening of the nuts 48 can prevent the brackets 14 from moving with respect to the main body 12. Unfastening the nuts 48 can enable a repositioning of the brackets 14.

As shown in FIG. 2, the cover 16 can include an opening 50 and two flaps 52 to couple the cover 16 to the main body 12. The flaps 52 can engage the flanges 44. The flaps 52 can each include a hole 54. In some embodiments, the flaps 52 can include segments, which can be positioned at angles with respect to each other. Screws 56 can be inserted through the openings 50 and the holes 54 to couple the cover 16 to the main body 12. Each screw 56 can be secured by a nut 58. In some embodiments, the flaps 52 can rotate when being coupled to the flanges 44, exerting a force onto the nuts 58. As a result, the screws 56 can be tightened without having to access the nuts 58. For example, the screws 56 can be tightened after the cover 16 has been attached to the main body 12 without having to use a wrench to hold the nuts 58.

In some embodiments, the cover 16 can include bevels 60. The bevels 60 can be coupled to the first section 36 and/or the side sections 38. In some embodiments, the bevels 60 do not obstruct the movement of the brackets 14. The bevels 60 can be substantially parallel to the sidewalls 20 of the main body 12 and/or the sidewalls 30 of the brackets 14.

As shown in FIG. 3, the joint plates 22 can be slightly narrower than the width of the base plate 18 so that the sidewalls 20 do not obstruct the movement of the joint plates 22. The connection between the joint plates 22 and the base plate 18 through the deformable hinges 24 can result in a horizontal offset D between the joint plates 22 and the base plate 18. In some embodiments, the offset D can help properly align the cross member 28 of the brackets 14 with the base plate 18.

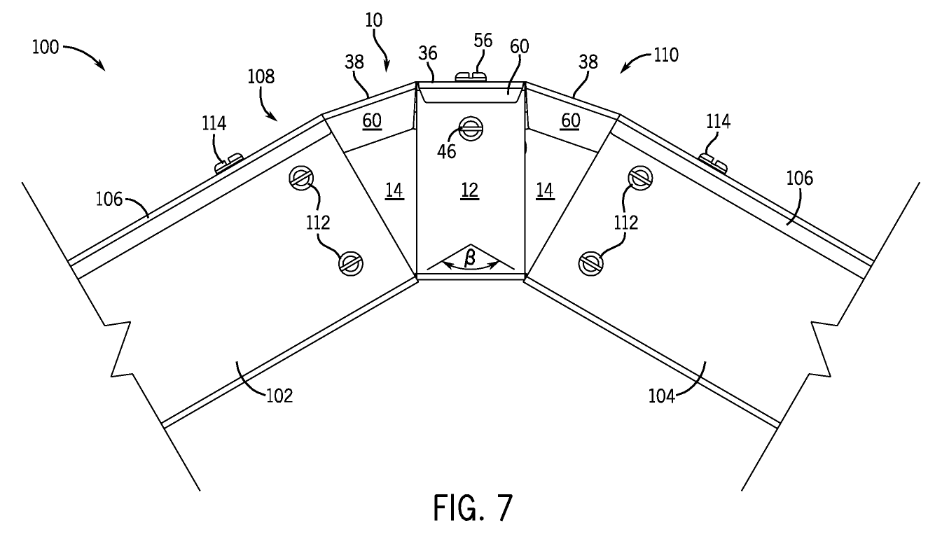

As also shown in FIG. 3, the joint plates 22 can rotate about an angle α with respect to the base plate 18. In some embodiments, the angle α can range from about 45 degrees to about 270 degrees. In other embodiments, the angle α can range from about 90 degrees to about 180 degrees. The angle α can determine an angle β of the variable angle fitting 10, as shown in FIG. 7. If the angle β equals about 180 degrees, the variable cable fitting 10 can serve as an extension for a cable route. If the angle β is about zero degrees, the variable angle fitting 10 can define a U-turn in the cable route. In some embodiments, the screws 46 can be used to fix the angle α and/or the angle β.

The distance between the joint plates 22 can be determined by the width of the base plate 18. In some embodiments, the width of the base plate 18 can be adapted to provide a minimum bend radius for the cables and wires installed in the variable angle fitting 10.

FIG. 4 illustrates one of the two identical brackets 14. In some embodiments, the slots 32 of each brackets 14 can be positioned adjacent to an upper end of each sidewall 30. In some embodiments, the slots 32 can include a center of curvature that coincides with the deformable hinge 24. When the brackets 14 are coupled to the main body 12, the slots 32 can be aligned with the openings 42 throughout the movement of the brackets 14. In some embodiments, the sidewalls 30 of the two identical brackets 14 can be laterally offset by the thickness of the bracket material, as shown in FIGS. 2 and 6, and can be sized to both fit between the sidewalls 20 of the main body 12.

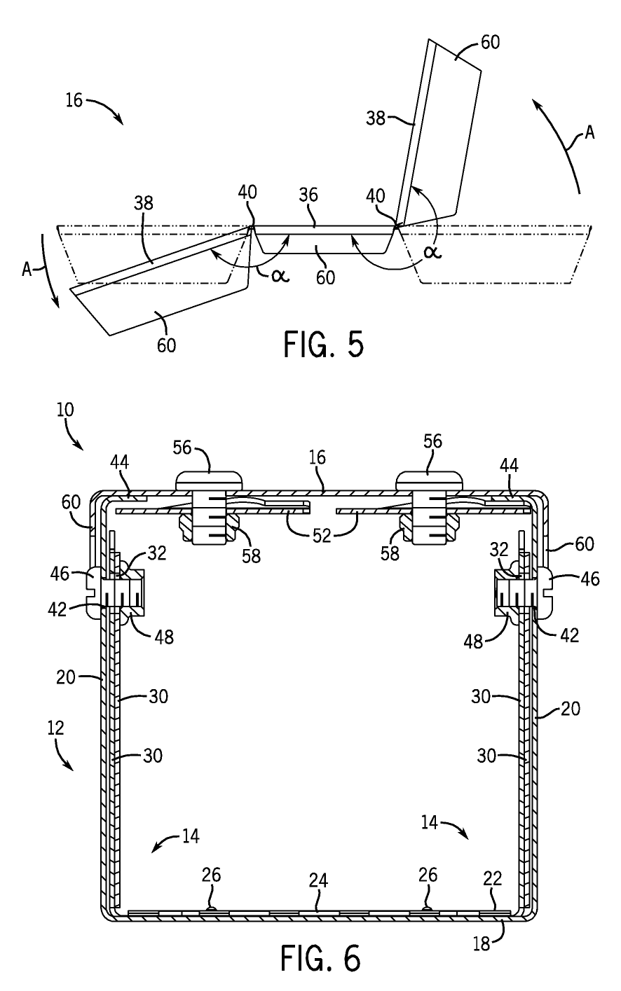

FIG. 5 illustrates the cover 16 according to one embodiment of the invention. The perforations 40 can enable the cover 16 to bend (as indicated by arrows A) at the angles α. In some embodiments, the first section 36 can be coupled to the main body 12 before the side sections 38 are bent in order to cover the brackets 14.

FIG. 6 illustrates a cross-section of the assembled variable angle fitting 10. In some embodiments, the main body 12 can surround the brackets 14, and the cover 16 can substantially enclose the main body 12. In some embodiments, the screws 46 and the nuts 48 can press the sidewalls 30 of the brackets 14 against the sidewalls 20 of the main body 12. The cover 16 can be coupled to the variable angle fitting 10 using the flanges 44. In some embodiments, the flaps 52 can reach under the flange 44 preventing vertical movement of the cover 16 with respect to the main body 12. Friction can hold the cover 16 horizontally in place. The screws 46 and 56 can be positioned without interfering with installed cables and/or wires routed through the variable angle fitting 10. In some embodiments, the screws 46 and 56 can be positioned toward an upper end of the variable angle fitting 10.

FIG. 7 illustrates a cable routing system 100 including the variable angle fitting 10, a first elongated cable routing device 102, and a second elongated cable routing device 104. In some embodiments, the first cable routing device 102 and the second cable routing device 104 can each include a cover 106. To install the variable angle fitting 10, the screws 46 can be loosened, allowing the brackets 14 to rotate with respect to the main body 12. A first end 108 of the variable angle fitting 10 can be coupled to the first cable routing device 102. In some embodiments, the first cable routing device 102 can be coupled to one of the brackets 14. A second end 110 of the variable angle fitting 10 can be coupled to the second cable routing device 104. In some embodiments, the second cable routing device 104 can be coupled to the main body 12 while, in other embodiments, the second cable routing device 104 can be coupled to one of the brackets 14. In some embodiments, fasteners 112 can pass through the apertures 34 in order to couple the first cable routing device 102 and/or the second cable routing device 104 to the variable angle fitting 10.

If the second cable routing device 104 is coupled to a structure (e.g., a wall of a building), the screws 46 can be tightened in order to fix the angle β of the variable angle fitting 10. If the second cable routing device 104 is not attached to a structure, the second cable routing device 104 can be positioned and attached to the structure at a desired position. The screws 46 can then be fastened to fix the angle β of the variable angle fitting 10. If desired, the covers 106 can be installed on the first cable routing device 102 and/or the second cable routing cable 104. In some embodiments, the covers 106 can be coupled to the first cable routing device 102 and/or the second cable routing device 104 using fasteners 114. The covers 106 can engage the cover 16 of the variable angle fitting 10. In some embodiments, the fasteners 114 can couple the covers 106 to the side sections 38 of the cover 16. In some embodiments, the side sections 38 and/or the bevels 60 can be trimmed for a tight fit.

In some embodiments, the screws 46 can be replaced by extensions of the sidewalls 20 of the main body 12. The extensions can engage with the slots 32, which can, for example, include a corrugated pattern to secure a certain position. The variable angle fitting 10 can be manufactured from materials such as stainless steel and/or plastic.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. Various features and advantages of the invention are set forth in the following claims.

1. A variable angle fitting to route cables around a corner, the variable angle fitting comprising:
a main body including a base plate, a first sidewall, a second sidewall, a first joint plate, and a second joint plate, the first sidewall and the second sidewall substantially perpendicular to the base plate, the first joint plate rotatably coupled to the base plate by a first deformable hinge, the second joint plate rotatably coupled to the base plate by a second deformable hinge; and
a first bracket and a second bracket, the first bracket being identical to the second bracket, the first bracket coupled to the first joint plate, the second bracket coupled to the second joint plate, the first bracket being positioned at a first angle with respect to the base plate and the second bracket being positioned at a second angle with respect to the base plate in order to route cables around the corner.

2. The variable angle fitting of claim 1, and further comprising a first screw coupling the first bracket and the second bracket to the first sidewall of the main body, and a second screw coupling the first bracket and the second bracket to the second sidewall of the main body.

3. The variable angle fitting of claim 1, wherein the first sidewall and the second sidewall of the main body form a trough.

4. The variable angle fitting of claim 1, wherein the first bracket and the second bracket each include a curved slot to receive at least one screw.

5. The variable angle fitting of claim 1, wherein the first joint plate and the second joint plate are rotatable an angle between about 45 and about 270 degrees with respect to the base plate.

6. The variable angle fitting of claim 1, and further comprising a cover that attaches to flanges of the first side wall and the second sidewall of the main body.

7. The variable angle fitting of claim 1, wherein the first deformable hinge and the second deformable hinge each include perforations.

8. The variable angle fitting of claim 1, wherein the main body, the first bracket, and the second bracket are constructed of at least one of stainless steel and plastic.

9. A cable routing system to route cables around a corner, the cable routing system comprising:
a variable angle fitting including
a main body including a base plate, a first sidewall, a second sidewall, a first joint plate, and a second joint plate, the first sidewall and the second sidewall substantially perpendicular to the base plate, the first joint plate rotatably coupled to the base plate by a first deformable hinge, the second joint plate rotatably coupled to the base plate by a second deformable hinge; and
a first bracket and a second bracket, the first bracket being identical to the second bracket, the first bracket coupled to the first joint plate, the second bracket coupled to the second joint plate, the first bracket being positioned at a first angle with respect to the base plate and the second bracket being positioned at a second angle with respect to the base plate in order to route cables around the corner; and
a first elongated cable routing device coupled to the first bracket; and
a second elongated cable routing device coupled to the second bracket.

10. The cable routing system of claim 9, and further comprising a first screw coupling the first bracket and the second bracket to the first sidewall of the main body, and a second screw coupling the first bracket and the second bracket to the second sidewall of the main body.

11. The cable routing system of claim 9, wherein the first sidewall and the second sidewall of the main body form a trough.

12. The cable routing system of claim 9, wherein the first bracket and the second bracket each include a curved slot to receive at least one screw.

13. The cable routing system of claim 9, wherein the first joint plate and the second joint plate are rotatable an angle between about 45 and about 270 degrees with respect to the base plate.

14. The cable routing system of claim 9, and further comprising a cover that attaches to flanges of the first side wall and the second sidewall of the main body.

15. The cable routing system of claim 14, and further comprising additional covers that attach to the first elongated cable routing device and the second elongated cable routing device.

16. The cable routing system of claim 9, wherein the first elongated cable routing device and the second elongated cable routing device are each coupled to walls of a building.

17. The cable routing system of claim 9, wherein the variable angle fitting, the first elongated cable routing device, and the second elongated cable routing device are constructed of at least one of stainless steel and plastic.
